(19) United States
(12) Patent Application Publication
(10) Pub. No.: US 2019/0213900 A1
(43) Pub. Date: Jul. 11, 2019

(54) GENERATING SELECTABLE CONTROL ITEMS FOR A LEARNER

(71) Applicant: International Business Machines Corporation, Armonk, NY (US)

(72) Inventors: Thomas D. Erickson, Minneapolis, MN (US); Jonathan Lenchner, North Salem, NY (US); Clifford A. Pickover, Yorktown Heights, NY (US); Komminist Weldemariam, Nairobi (KE)

(21) Appl. No.: 15/868,561

(22) Filed: Jan. 11, 2018

(51) Int. Cl. G09B 5/12; G06F 3/0482; G09B 5/06; G09B 7/02

(52) U.S. Cl. CPC G09B 5/12; G06F 3/0482; G09B 7/02; G09B 5/065; G09B 5/125

(57) ABSTRACT

A computer-implemented method executed by an adaptive learning system is disclosed that includes the step of receiving a first set of user data associated with a learner. The method stores the first set of user data. The method predicts at least one user interaction activity based on the first set of user data. The method identifies engagement factors for the user in the first set of user data. The method determines a set of engagement models based on the at least one predicted user interaction event, the first set of user data, and the identified engagement factors. The method generates a first set of control items based on the set of engagement models.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure relates generally to adaptive learning systems. Adaptive learning systems are configured to adapt a presentation of educational or training material according to a user's needs, which is generally indicated by the user's response to questions, tasks, and/or based on the user's level of experience or knowledge.

### SUMMARY

The disclosed embodiments include an adaptive learning system, a computer-implemented method executed by an adaptive learning system, and a computer program product for providing adaptive learning.

As an example embodiment, a computer-implemented method executed by an adaptive learning system is disclosed that includes the step of estimating learning factors of a learner with respect to a content item. The method generates at least one user interaction activity associated with the content item using the estimated learning factors of the learner. The method displays the at least one user interaction activity on a display.

In various embodiments, the learning factors may include a learner context and a learner cohort. In various embodiments, the method may determine an unused portion within the display that is not currently being utilized and display the at least one user interaction activity in the unused portion of the display. In various embodiments, the method may determine an optimal time for displaying the at least one user interaction activity. In various embodiments, the at least one user interaction activity may include one or more selectable control items such as, but not limited to, pausing, starting, stopping, fast forwarding, rewinding, zoom-in, zoom-out, clicking, hovering, taking a note, asking question, highlighting a word/phrase/concept, and typing feedback.

As another example embodiment, a computer-implemented method executed by an adaptive learning system is disclosed that includes the step of receiving a first set of user data associated with a learner. The computer-implemented method stores the first set of user data. The computer-implemented method predicts at least one user interaction activity based on the first set of user data. The computer-implemented method identifies engagement factors for the user in the first set of user data. The computer-implemented method determines a set of engagement models based on the at least one predicted user interaction event, the first set of user data, and the identified engagement factors. The computer-implemented method generates a first set of control items based on the set of engagement models.

In various embodiments, the first set of user data comprises historic learning data of the learner. In various embodiments, the computer-implemented method may further be configured to select an optimal set of control items based on at least one optimization objective and the first set of control items. In various embodiments, the computer-implemented method may further be configured to determine commands or shortcuts; determine a location for displaying the optimal set of control items; and display the optimal set of control items at the location of a display. In certain embodiments, the computer-implemented method may further be configured to identify an unused space within the display for displaying one or more control items. In some embodiments, the computer-implemented method may also be configured to determine an optimum time for displaying one or more control items.

In various embodiments, the computer-implemented method may be configured to monitor user interactions with the one or more control items. The computer-implemented method may be configured to analyze an outcome of the user interactions with the one or more control items. In certain embodiments, the computer-implemented method may be configured to perform an amelioration action such as, but not limited to, deprioritizing at least one control item and/or employing a break-away avatar to interact with the learner in response to a determination that the outcome is negative.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a predictive learning module in accordance with various embodiments of the present disclosure.

FIG. 2 is a schematic diagram illustrating a content item on an end user device in accordance with various embodiments of the present disclosure.

FIG. 3 is a flowchart illustrating a process for generating and displaying at least one user interaction activity related to a content item in accordance with various embodiments of the present disclosure.

FIG. 4 is a flowchart illustrating a process for displaying selectable control items related to a content item in accordance with various embodiments of the present disclosure.

FIG. 5 is a flowchart illustrating a process for displaying the selectable control items related to a content item in accordance with various embodiments of the present disclosure.

FIG. 6 is a flowchart illustrating a process for monitoring the effects of selectable control items in accordance with various embodiments of the present disclosure.

FIG. 7 is a block diagram of an adaptive learning adaptive learning system in accordance with various embodiments of the present disclosure.

The illustrated figures are only exemplary and are not intended to assert or imply any limitation with regard to the environment, architecture, design, or process in which different embodiments may be implemented. Any optional component or steps are indicated using dash lines in the illustrated figures.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

A module as referenced herein may comprise of software components such as, but not limited to, data access objects, service components, user interface components, application programming interface (API) components; hardware components such as electrical circuitry, processors, and memory; and/or a combination thereof. The memory may be volatile memory or non-volatile memory that stores data and computer executable instructions. The computer executable instructions may be in any form including, but not limited to, machine code, assembly code, and high-level programming code written in any programming language. The module may be configured to use the data to execute one or more instructions to perform one or more tasks.

As referenced herein, the term “communicatively coupled” means capable of sending and/or data over one or more communication links. In certain embodiments, the communication links may also encompass internal communication between various components of a system and/or with an external input/output device such as a keyboard or display device. Additionally, the communication links may include both wired and/or wireless links, and may be a direct link or may comprise of multiple links passing through one or more communication network devices such as, but not limited to, routers, firewalls, servers, and switches. The network device may be located on various types of networks. A network as used herein means a system of electronic devices that are joined together via communication links to enable the exchanging of information and/or the sharing of resources. Non-limiting examples of networks include local-area networks (LANs), wide-area networks (WANs), and metropolitan-area networks (MANs). The networks may include one or more private networks and/or public networks such as the Internet. The networks may employ any type of communication standards and/or protocol.

The disclosed embodiments seek to improve adaptive learning systems. As stated above, current adaptive learning systems are configured to adapt a presentation of educational or training material according to a learner's needs, which is generally indicated by the learner's response to questions and/or tasks; based on the learner's level of experience or knowledge; and/or based on the learner's interaction with the adaptive learning systems/training material. For example, the adaptive learning systems may be configured to identify when the learner performs the following actions: pause, start, stop, fast forward, rewind; zoom-in, zoom-out, click, hover, take a note, ask a question, highlight on a work/phrase, and provide feedback. These actions and other actions associated with the learner's interaction with the presentation of educational or training material are referred to herein as activities. Typically, the learner performs these activities based on his/her gut-feeling, or sometime based on their understanding of the concept, content or topic, and/or based on some contextual factors (feeling happy, sad, bored, and sleepy, etc.). However, many learners do not know when to engage effectively with given learning content (e.g. when to take a note, when to underline on a concept or topic, when to go back-and-forth between pages or segments of the content, etc.) or even when to pause to rest. Thus, the disclosed embodiments seek to improve current adaptive learning systems by providing adaptive learning systems that are configured to generate and recommend one or more activities to the learner based on the analysis of the learner context, learner cohort, content characteristics, and so on.

Advantages of the disclosed embodiments over current adaptive learning systems include proactively providing an alert, hint, or other indication to a learner when to perform one or more activities instead of simply reacting to such activities from the learner. In other words, the disclosed embodiments not only indicates to a user what is important, but also indicates to the user how best to learn the material and provides the indication at the optimum time for learning. This approach maximizes or increases the learning experience.

While the disclosed embodiments are described with respect to an education/training application, the disclosed embodiments may be applied to various other applications including, but not limited to, applications involving electronic-commerce (eCommerce) web sites, ordering web sites, streaming video sites, and the like that may benefit from proactively indicating the learner.

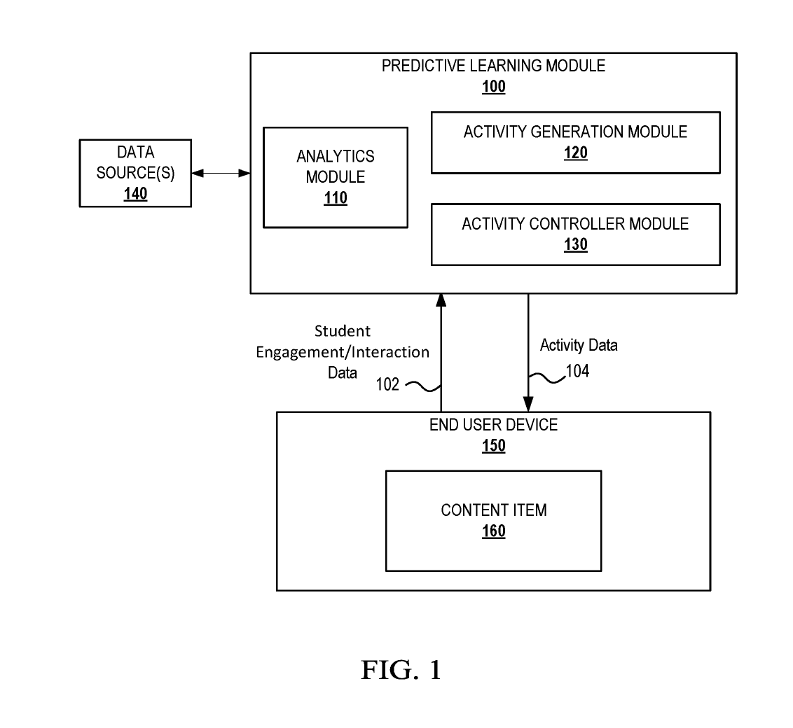

FIG. 1 is a schematic diagram illustrating a predictive learning module 100 in accordance with various embodiments of the present disclosure. In the depicted embodiment, the predictive learning module 100 is communicatively coupled to at least one end user device 150 and one or more data sources 140. In various embodiments, the predictive learning module 100 may be incorporated or executed within an end user device 150. In some embodiments, the predictive learning module 100 may be integrated within a particular content item 160 (e.g., a learning application) and configured to provide the services described herein for particular content item 160 on the end user device 150. In other embodiments, the predictive learning module 100 may be a separate service or program executed on the end user device 150 and configured to provide the services described herein for one or more content item 160 on the end user device 150. In any of these or other embodiments, all or a portion of the predictive learning module 100 may be executed on a network device that is communicatively coupled to the end user device 150. The predictive learning module 100 may be configured to provide the services described herein to one or more content item 160 being executed on one or more end user device 150. The predictive learning module 100 may run in the background, while the learner interacts with the learning materials and generates her own activities within the content item 160. Finally, the predictive learning module 100 may display commands (clickable, brief textual descriptions of suggested activities) alongside the learning content, so that the learner can interact with the content.

The end user device 150 may be any type of electronic device such as, but not limited to, a personal computer, a laptop, a tablet, a smart phone, a smart watch, electronic eyewear, mobile phone, a television, or other user electronic devices that include memory and a processor that are capable of storing and executing instructions for performing features of the disclosed embodiments. In various embodiments, the end user device 150 may also include a microphone, an audio output component such as a speaker, a built-in display or display interface for communicatively coupling with a display device, and a network interface for communicating with one or more devices on a network. The end user device 150 may also include one or more input interfaces for receiving information from a user. In certain embodiments, the end user device 150 may include a camera for capturing images and/or for enabling the predictive learning module 100 to visually monitor a learner's attentiveness to a content item 160 that is being displayed on the end user device 150.

The content item 160 may be any type of program or application are capable of displaying information to a user. For example, in some embodiments, the content item 160 may be a specially designed learning application with a graphical user interface (GUI) that enables a user to learn a particular subject or topic. In various embodiments, the content item 160 may be a web browser, a media player, a PowerPoint® or other types of presentation software, or any other application that is capable of presenting information to a user.

The one or more data sources 140 may include one or more databases that contain content that a user may wish to learn about. For example, the data source 140 may include various educational content such as history, English, physics, calculus, vehicle repair or maintenance, and gardening tips. The data source 140 may also include one or more knowledge graphs, adaptive learning or engagement models, learner profile database, or other sources of information that may be utilized by the predictive learning module 100.

As shown in FIG. 1, the predictive learning module 100 is configured to receive student engagement/interaction data 102 from the end user device 150. In one embodiment, the student engagement/interaction data may include data regarding the student's interaction with the content item 160 (e.g., control features that were selected by the user, whether the student paused or took notes/highlighted text, and sensor or image data that indicate level of attentiveness). In various embodiments, the predictive learning module 100 analyzes the engagement/interaction data in real-time to provide one or more user activities/user-selectable control items (activity data 104) to the end user device 150 that is predicted to assist the user in learning content item 160.

In the depicted embodiment, the predictive learning module 100 includes an analytics module 110, an activity generation module 120, and an activity controller module 130. In various embodiments, the analytics module 110 is configured to predictively determine one or more user-selectable control items that may assist a user in the learning. In various embodiments, the analytics module 110 determines which user-selectable control items are displayed, how they function, where they appear, when they appear, and in what form. As will be further discussed, non-limiting examples of user-selectable control items include hyperlinks and selectable buttons that perform a particular action such as, but not limited to, providing additional information to a user (e.g., jumps to a particular section, another presentation or class, or initiates an avatar that may provide additional information or guidance) and/or causing a particular function to be performed (rewind a video presentation of a course to a particular topic, initiates a pause for a user to take additional notes, inform the user of an important concept, etc.). In various embodiments, the analytics module 110 may start by receiving a set of user data. In various embodiments, the set of user data may include historic learner data such as a learner's prior engagement and interaction with a particular content item. The set of user data may also include information gathered from how other users have approached learning a particular content item. For example, the set of user data may indicate that other users spend more time focusing on a particular segment, pauses a course for additional notes at a particular time, rewind or re-watch particular segments, etc. In various embodiments, the analytics module 110 is configured to estimate learning factors or engagement factors of a learner (i.e., factors that may be used to predict effective learning) with respect to a content item based the set of user data. Examples of learning factors include a learner context and a learner cohort and are further described below. The analytics module 110 may then use the identified learning/engagement factors determining one or more user-selectable control items for the learner.

In various embodiments, the activity generation module 120 is configured to generate the one or more user-selectable control items. For instance, in various embodiments, the activity generation module 120 may be configured to receive the one or more user-selectable control items, determine commands or shortcuts for the one or more user-selectable control items such as, but not limited to, the function, hyperlinks, timing, appearance, and location of the one or more user-selectable control items. The activity generation module 120 is then configured to generate the one or more user-selectable control items in accordance with their configurations.

In various embodiments, the activity controller module 130 is configured to monitor in real time the activities of the learner with respect to the content item 160 and/or the one or more user-selectable control items. In various embodiments, the activity controller module 130 may be configured to determine the effectiveness of the one or more user-selectable control items by monitoring a user's interaction. In certain embodiments, if the activity controller module 130 identifies that one or more of the user-selectable control items has a negative impact or provides no effective value to the user, the activity controller module 130 may be configured to adjust one or more characteristics of a user-selectable control item. In certain embodiments, the activity controller module 130 may also identify what works with a particular user and modify one or more user-selectable control items in real time based on the updated user profile information.

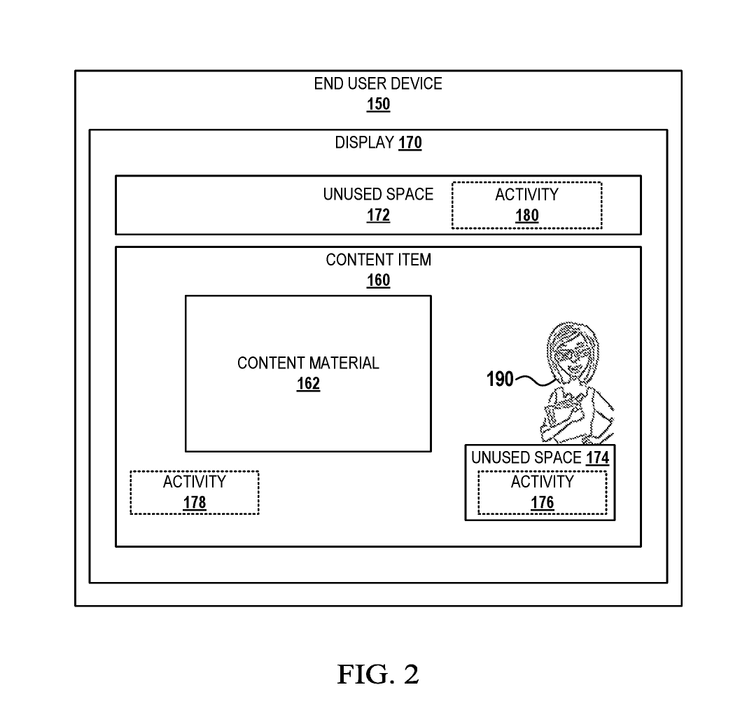

FIG. 2 is a schematic diagram illustrating a content item 160 on an end user device 150 in accordance with various embodiments of the present disclosure. In the depicted embodiment, the end user device 150 includes a display 170 that is integrated with the end user device 150 such as a tablet, smartphone, or laptop computing device. In one embodiment, the content item 160 is a learning application that has a graphical user interface for displaying content material 162. The graphical user interface of the content item 160 may include one or more permanent user-selectable control features (e.g., buttons, links, etc.). In the depicted embodiment, the content item 160 uses only a portion of the display 170. The display 170 may include one or more unused space such as unused space 172. Additionally, the content item 160 may also include one or more unused space such as unused space 174. As will be further described, the unused space 172 and unused space 174 may be used to display one or more user selectable control items/activities such as activity 176 and activity 180. Additionally, in various embodiments, one or more user selectable control items/activities such as activity 178 may be displayed within the graphical user interface of the content item 160. For example, in certain embodiments, the content material 162 may be shifted or adjusted for displaying one or more user selectable control items/activities. In one embodiment, the one or more user selectable control items/activities such as activity 176 may be displayed over a portion of the content material 162 or the graphical user interface of the content item 160 in an area that does not materially affect the content item 162 or the or the graphical user interface of the content item 160.

Additionally, an avatar 190 may be presented on the display 170 of the end user device 150. For example, the avatar may be used in assisting a learner when the user indicates that additional assistance is needed or when the system identifies a lack of engagement by the user. For instance, if a lecturer is presenting content in a video-like course and the system identifies a lack of engagement by the user, the system may pause the course and the avatar 190 (which in certain embodiments may represent the lecturer) may appear and break away from the presentation to speak to the user to convey information and activity recommendations (also referred to herein as a break-away avatar). Once the user's attention has returned or the user has taken a useful action, the avatar 190 may fade away or merge with the original lecturer. In various embodiments, the avatar 190 may be selected based on the user's profile. For certain groups of students (e.g., those who are quite young, those that are old, those with autism, those with pre-Alzheimer's, etc.), the avatar 190 may bear a resemblance to the lecturer or it may morph to another form, such as a poodle, robot, or other form that engages with the user to make recommendations. In some embodiments, the precise useful nature of the avatar 190, its voice, and the form it takes may be learned. The break-away avatar may also be transformed into selectable activities that may benefit the learner. In some sense, the avatar 190 may serve as the means through which the system conveys activities, commands, and suggestions. For example, the avatar 190 may be selectable so as to initiate an activity. The break-away avatar 190 may also optionally be placed in an optimized local setting (environment) when the avatar 190 is presented to a user. For example, the break-away avatar 190 may be presented, sitting on a tree branch (perhaps useful for children) or on a skateboard. The setting for the break-away avatar that tends to be useful (e.g. obtain a useful and quick user response) may be learned for a particular user or a cohort of users. In various embodiments, the setting may change through time, if a user is losing responsivity to the current setting.

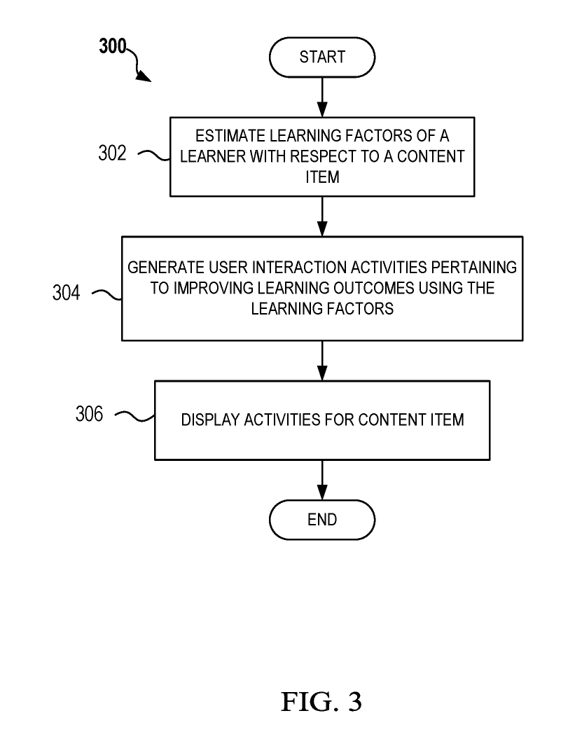

FIG. 3 is a flowchart illustrating a process 300 performed by an adaptive learning system that is configured to execute the predictive learning module 100 for generating and displaying at least one user interaction activity related to a content item in accordance with various embodiments of the present disclosure. The process 300 begins at step 302 by estimating learning factors of a learner with respect to a content item. In various embodiments, the learning factors of a learner include a learner context and a learner cohort. The learner context may include data relating to the interaction, attitude, motivation, and/or engagement patterns between the learner and the content item 160. The learner context may also include the physical characteristics of the environment in which the user is learning. For instance, the environment may be a non-conducive environment for learning (e.g. poor light, high temperature, ambient sound, etc.). The learner cohort refers to a model of a set of users who share one or more characteristics such as age, degree of ability, or level of expertise, and is used to predict characteristics of a new user who fits that cohort. In various embodiments, the learner cohort may be used to predict or estimate a learner's progression rate, understanding level, and/or cognitive/affective state of the learner with respect to the content item 160. For example, the learner cohort may be used to estimate that the learner will spend a total time of 40 minutes using the content item 160, but will only be engaged with the content item 160 for a total time 35 mins. The learner cohort may also be used to predict that the learner will have slow progress reading a particular segment of the lesson involving a particular topic.

At step 304, the process 300 generates one or more user interaction activities associated with the content item 160 using the learning factors. As referenced herein, the at least one user interaction events and/or activities may include selectable control items such as, but not limited to, buttons or hyperlinks for pausing, starting, stopping, rewinding, rewinding a set amount, rewinding to a particular point of interest or identified point that would assist the learner (similar options may be configured for fast forwarding), zooming-in, zooming-out, clicking, hovering, taking a note, asking question, highlighting a word/phrase/concept, and typing feedback. In some embodiments, the at least one user interaction activity may include cautioning against, blocking, and/or making it more difficult than normal for the learner to carry out certain activities that are associated with negative outcomes based on the learner cohort. For example, a fast forward feature may be disabled for parts that the learner has difficulty with. Additionally, the process 300 may be configured to determine if a user seeks out alternative explanations, or additional examples, from the web, and may be configured to provide additional hyperlinks or explanations in the form of one or more user interaction activities. Explanations may be textual, image-based, or even demonstration videos. In various embodiments, the process 300 continuously makes an effort to decide whether the student is seeking related material on the web or is taking a detour from his or her studying and is surfing the web for something unrelated. In various embodiments, certain features of the end user device 150 may also be disabled such as, but not limited to, the opening of another application or disabling a network connection.

In certain embodiments, the at least one user interaction activity may also include providing or employing a break-away avatar to interact with the learner with respect to the content item 160. For example, in one embodiment, if the learner is having attention problems, a break-away avatar may appear and provide tips, learning advice, or other learning material to the learner to assist the learner. A break-away avatar as used herein is an icon, image, figure, or some manifestation representing a particular person (e.g., a professor that is teaching the course that is being shown on the content item 160) or thing (e.g., may be a talking pencil or paperclip) that appears as a separate object from the content that is normally displayed on the content item 160. For instance, the break-away avatar may repeat the topics of a particular section, provide highlights, or even quiz the learner regarding a particular topic to determine his/her understanding.

At step 306, the process 300 displays one or more user interaction activities for the content item 160. In various embodiments, as part of displaying the one or more user interaction activities associated with the content item 160, the process 300 may be configured to determine an unused portion within the display of the end user device 150 that is not currently being utilized to display information. If the process 300 identifies an unused portion within the display of the end user device 150 that may be adequate for displaying the at least one user interaction activity, then the process 300 displays the at least one user interaction activity in the unused portion of the display. In various embodiments, the process 300 may be configured to determine an optimum time for displaying the one or more user interaction activities. For example, the process 300 may determine that the optimum time for displaying one or more user interaction activities is right after an important topic has been described by the content item 160.

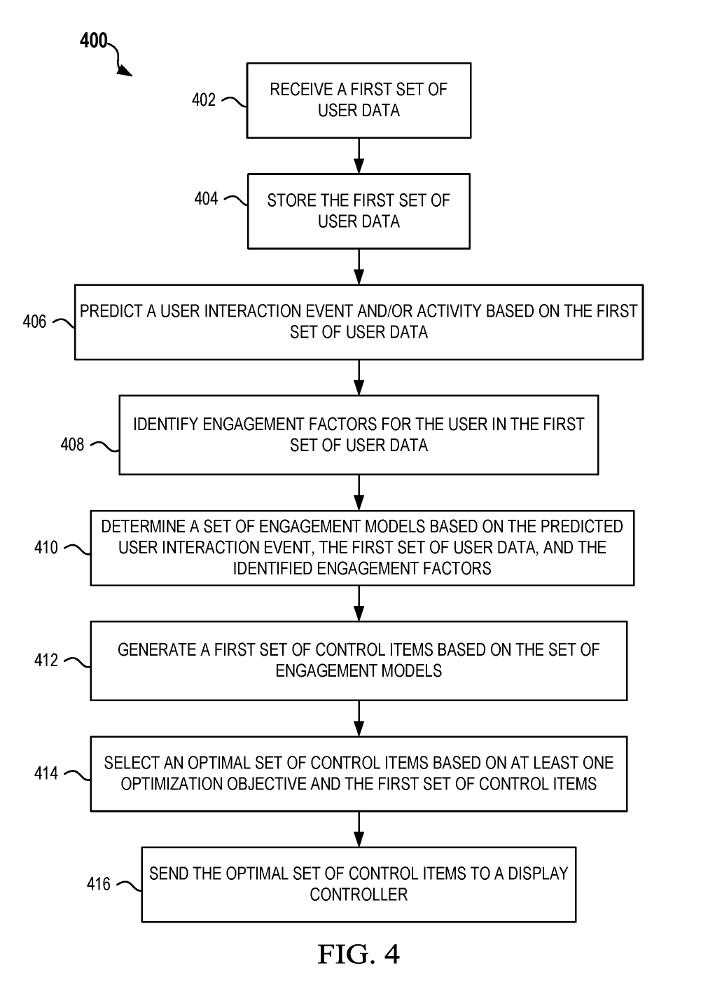

FIG. 4 is a flowchart illustrating a process 400 performed by an adaptive learning system that is configured to execute the predictive learning module 100 for displaying selectable control items related to a content item 160 in accordance with various embodiments of the present disclosure. For example, in various embodiments, the process 400 may be performed by executing one or more instructions associated with the analytics module 110 and the activity generation module 120 as shown in FIG. 1.

In the depicted embodiment, the process 400 begins at step 402 by receiving a first set of user data. In various embodiments, the first set of user data may include data from one or more digital learning system instrumentation devices or sensors. For example, the adaptive learning system may receive information related to the physical characteristics of the environment in which the user is learning (sound, light, temperature, etc.) from one or more sensors. In various embodiments, the sensors may be located anywhere near the end user device 150 (e.g., on a table or wall) and/or the sensors may be attached or integrated with the end user device 150. In one embodiment, the sensors are communicatively coupled to the end user device 150 through a wireless communication link.

In various embodiments, the adaptive learning system may also receive historic learner data such as a learner's prior engagement and interaction with content item 160. For example, the historic learner data may indicate that a user exhibits persistently low (or inappropriate) sentiment/emotion when it comes to interacting with the content item 160. The historic learner data may indicate the kind of feedback, options, and activities that a user actually benefits from (based on his continued interest in a topic, based on grades for a course, etc.). In various embodiments, the historic learner data may also indicate the learning characteristics of other learners. For example, the historic learner data may indicate that several students either took notes during a segment and/or underlined a particular concept in that segment. This data may indicate that a control item be provided to further discuss the particular concept during the segment. In various embodiments, the historic learner data may also be filtered for a particular cohort of users (e.g. young student, student with autism, adult student, etc.) that is associated with the current user.

In some embodiments, the adaptive learning system may also receive external information such as information gathered from a knowledge graph or other resources. A knowledge graph may contain semantic information gathered from a wide variety of sources. The semantic information may enable the adaptive learning system to better understand a learner's actions, responses, and/or requests to better assist the learner.

At step 404, the process 400 stores the first set of user data in memory or a data storage unit such as a hard drive. In various embodiments, the data storage unit may be configured as a database for storing the first set of user data or a database. In various embodiments, the first set of user data in may be stored in a local data storage unit/database on an end user device 150 and/or may be stored remotely on a network device in the cloud.

At step 406, the process 400 predicts a user interaction event and/or activity based on the first set of user data. For example, the process 400 may identify that the learner will likely have difficulty understanding a particular distinction between two concepts presented by the content item 160 based on the first set of user data and predict that the user will need to rewind to particular point in the presentation to review the distinction. As stated above, in various embodiments, the user interaction events and/or activities may also include cautioning against, blocking, or making it more difficult to carry out certain activities that are associated with negative outcomes for the learner cohort. For instance, when fast forwarding is known to be associated with negative outcomes for engagement or learning, the fast forwarding control may be disabled, or may be moved to a less prominent location; alternatively, its functionality might be changed so that the speed at which it went through the material was decreased or a pop up display is presented to alert the learner with the issues involved in fast forwarding through this section.

At step 408, the process 400 identifies engagement factors for the user in the first set of user data. Engagement factors are variables or actions that affect a level of engagement. In various embodiments, non-limiting examples of engagement factors may include user-interactions with the content item 160 (e.g., regular clicks, selects, pauses, rewinds, highlighting, or note taking may) that indicates that a user is engaged in learning, whereas little to no user-interaction between the user and the content item 160 may indicate that the learner is not engaged in learning. However, this may not be necessarily true, other engagement factors such as images or video captured using a camera device of the end user device 150 or screen/computer monitoring may indicate that the learner is engaged and focus on the content item 160 even though he does not regular interact with the content item 160. For example, an image or video of a user may be used for eye-tracking to determine a user's attentiveness. The image may also identify if a user is preoccupied such as, but not limited to, taking a phone call, performing other functions, or talking to others. The screen monitoring may also indicate that a user is interacting with or reviewing other open applications. Another engagement factor in the first set of user data may be the learner's history related to using the content item 160 or to a particular topic of learning. For example, if the first set of user data indicates that the user is highly interested in a particular subject, the user is likely to be engaged during the learning process.

In one embodiment, the process 400 at step 410 determines a set of engagement models (e.g., a user context model, a user cohort model, etc.) based on the predicted user interaction event, the first set of user data, and the identified engagement factors. In various embodiments, the engagement models may be statistical models that are able to predict the best way to engage a user in a user interaction or activity for a user with particular learning characteristics or traits.

At step 412, the process 400 generates a first set of control items based on the set of engagement models. The control items are items that enable control of the learning process associated with the content item 160. For example, non-limiting examples of control items includes a graphical user interface or a portion thereof such as an graphical push button (e.g., stop, pause, rewind, fast forward), selectable text, a link (e.g., link may take user to another page or lesson), an icon (e.g., icon may open up a file), an image (e.g., may open an image related to the topic of discussion), an avatar (e.g., generates a break away avatar that assists a learner), and/or any other type of control indicator.

In some embodiments, the process 400 at step 414 selects an optimal set of control items based on at least one optimization objective (e.g., a prioritization function) and the first set of control items. For example, the process 400 may determine that the optimum set of control items for the particular learner based on the first set of control items are control items that enable the user to rewind to the beginning of particular topics discussions and the use of an avatar that helps walk the user through the lesson by providing additional explanations and examples after each topic is discussed and/or provides an introduction to each section prior to the topic being discussed. In various embodiments, the process 400 may also determine the optimum time or non-optimum time for displaying one or more of the control items from the optimum set of control items. For example, the process 400 may determine that one or more of the control items from the optimum set of control items should not be displayed during a certain period of time as it would likely distract the user from learning. Whereas, the process 400 may determine that one or more of the control items from the optimum set of control items should displayed at a particular time to be the most effective. In various embodiments, the process 400 may also determine how long to display one or more of the control items from the optimum set of control items (e.g., one or more of the control items from the optimum set of control items might be displayed for only a set amount of time after the occurrence of some event).

At step 416, the process 400 sends the optimal set of control items to the display controller of a digital learning system the user computing device for enabling display of the optimal set of control items.

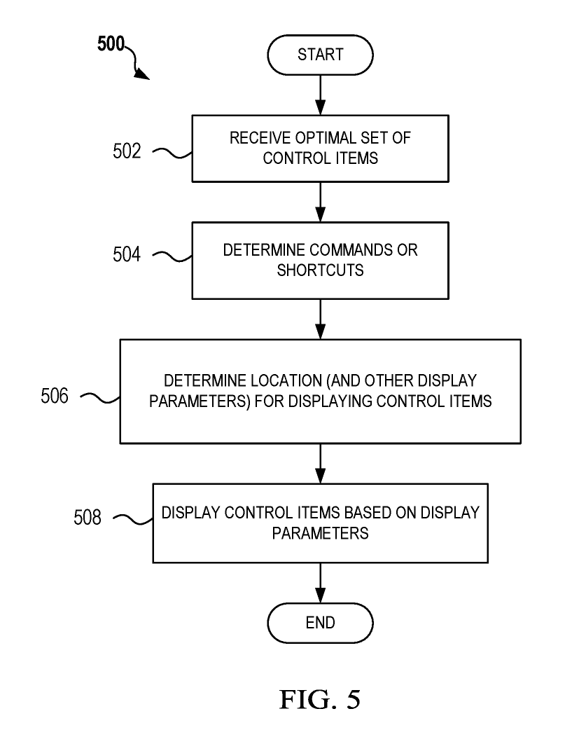

FIG. 5 is a flowchart illustrating a process 500 performed by an adaptive learning system that is configured to execute the predictive learning module 100 for displaying the selectable control items related to a content item 160 in accordance with various embodiments of the present disclosure. For example, in various embodiments, the process 500 may be performed by executing one or more instructions associated with the activity controller module 130 as shown in FIG. 1.

In the depicted embodiment, the process 500 begins at step 502 by receiving the optimal set of control items or recommended set of activities (e.g., from the activity generation module 120 as described in FIG. 4). In one embodiment, the process 500 at step 504 determines one or more commands or shortcuts. For example, in certain embodiments, the process 500 translates the generated optimal set of control items/recommended set of activities to intractable items in the form of commands or shortcuts. As referenced herein a shortcut is a button or hyperlink associated with the textually rendered commands, which when clicked, actually implements the user interaction event and/or activity (e.g., rewind or highlighting).

In one embodiment, the process 500 at step 506 determines a location and optionally an optimum time or other display parameters for displaying one or more control items from the optimal set of control items. In various embodiments, the process may determine an unused part of the graphical user interface or display on the end user device 150 (e.g., a tablet device) for displaying the one or more control items. In various embodiments, the characteristic, timing, and location of commands and/or shortcuts may be determined at runtime based on an analysis of an unused part of the GUI of the content item 160 or display. An unused part of the graphical user interface is a part that is not currently being used to display any information on the graphical user interface of the content item 160. In some embodiments, an unused part may also be an area of the display that is outside the boundaries of the graphical user interface of the content item 160 but is available for displaying information. Additionally, unused part of the graphical user interface or display may be a portion of the graphical user interface or display that is in use, but is displaying immaterial matter that may be obscured. For example, the content item 160 is presenting a slide presentation that contains slides, each of which has a set margin area or a region on each slide that is not being used to display any material information. In certain embodiments, these regions, while technically being used by the graphical user interface, may be considered as an unused part of the graphical user interface for the purpose of displaying one or more of the control items from the optimum set of control items.

In some embodiments, such as a learning system using a virtual reality or augmented reality system, the display may be worn and its contents will shift depending on where the user is looking. For example, in the case of a virtual reality system, portions of the display will show a virtual environment that serves as a background for the learning activity, and such areas, while technically being used by the system, may be considered as an unused part of virtual reality interface or display for the purpose of displaying on or more of the control items from the optimum set of control items.

In some embodiments, the unused part of the graphical user interface or display may be located on a secondary device that is communicatively coupled to the end user device 150. For example, in one embodiment, the secondary device may be a user's smartphone, if the user is using a tablet device or laptop as the main learning device (i.e., end user device 150).

Additionally, the process 500 may be configured to make room for displaying one or more of the control items within a graphical user interface. For example, a video course may make room for one or more of the control items by reducing the size of its picture or by shifting the image or certain content to one side to allow for displaying of the one or more of the control items. In some embodiments, this process may optionally be performed using a pre-defined region of the graphical user interface.

The process 500 at step 508 displays the one or more of the control items from the optimum set of control items based on their display parameters (e.g., location, timing, appearance, for how long, etc.). For example, in one embodiment, the process 500 displays the one or more of the control items from the optimum set of control items on an unused part of the graphical user interface of the digital learning system. In various embodiments, the one or more of the control items may also be an audio recommendation or some other audio recording that is played through an audio output component of the end user device 150.

In one embodiment, the process 500 may determine the ideal location for displaying the one or more of the control items from the optimum set of control items if there is more than one unused part of the graphical user interface or display available to the process 500. Still, the process 500 may determine the ideal or optimum timing for when to display the one or more of the control items from the optimum set of control items in the unused part of the graphical user interface of the digital learning system. In some embodiments, the process 500 may be configured to display the one or more of the control items from the optimum set of control items in a used portion of the graphical user interface or display if an unused portion of the graphical user interface or display is not available. In certain embodiments, the one or more of the control items from the optimum set of control items may be semi-transparent so as to limit the portion of the graphical user interface or display from being completely obscured.

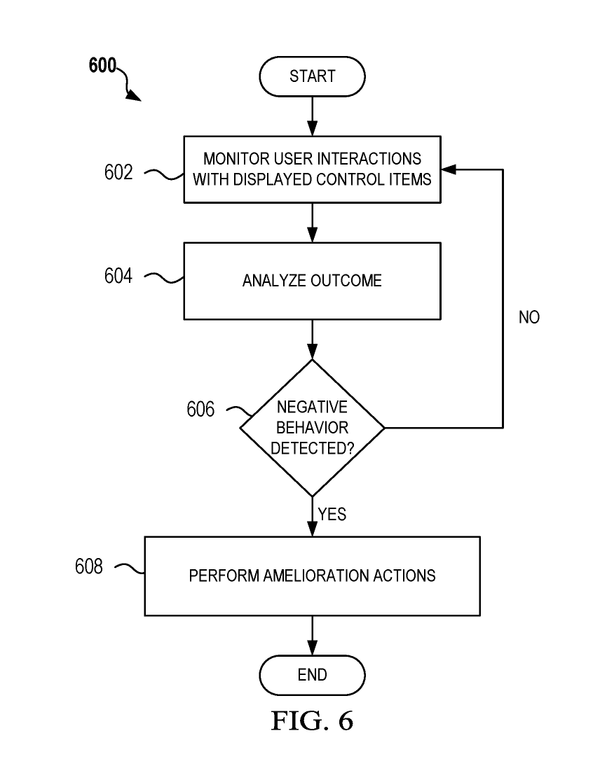

FIG. 6 is a flowchart illustrating a process 600 performed by an adaptive learning system that is configured to execute the predictive learning module 100 for monitoring the effects of selectable control items in accordance with various embodiments of the present disclosure. For example, the process 600 may be performed by executing one or more instructions associated with the analytics module 110 as shown in FIG. 1.

In the depicted embodiment, the process 600 begins at step 602 by monitoring the user activities or interactions with respect to one or more of the displayed control items. For example, the process 600 may monitor how long the one or more of the displayed control items were displayed before a user interacted with the control item (e.g., initiated the control item), closed the control item, and/or if the control item timed out.

At step 604, the process 600 is configured to analyze, in real-time or near real-time, the outcomes of the one or more control items based on the monitored user activities or interactions. For example, if the learner initiates a control item, the process 600 determines if it affected a behavioral change such as increase learner engagement, learner's understanding, and/or learner's retention of the material.

At step 606, the process 600 determines based on the real-time analysis of the learner's interaction with the one or more control items, whether the learner's interaction with the one or more control items resulted in a negative learner behavior. For example, if after displaying or initiating one or more of the displayed control items, the learner becomes less engaged with the content item 160, then the analysis may determine that displaying or initiating one or more of the displayed control items results in a negative learner behavior. In various embodiments, the process 600 may be configured to determine a numeric score that indicates a degree of effectiveness of a user-selectable control item. For example, in some embodiments, the numeric score may account for a level of engagement as measured by a user's activities, time spent on a segment in comparison to others, and attentiveness during the segment. In certain embodiments, the numeric score may be provided to the user as a form of feedback to the user. In various embodiments, the numeric score may be generated per segment, topic, and timeframe. This score may allow students to go back and review certain segments in which he may have received a low score. If the process 600 determines that displaying or initiating one or more of the displayed control items does not result in negative learner behavior, process 600 returns to step 602 and continues to monitor user activities or interactions with respect to one or more of the displayed control items.

If at step 606, the process 600 determines that displaying or initiating one or more of the displayed control items results in a negative learner behavior, the process 600 proceeds to step 608 where it performs one or more amelioration actions. For example, in some embodiments, the process 600 may deprioritize certain activities/control items associated with negative outcomes, and/or may initiate a break-away avatar to help address the negative learner behavior. In certain embodiments, the process 600 may be configured to notify a third party (e.g., a teacher, parent, training coordinator, etc.) if a negative learning behaviors identified, or a numeric score as described above is below a certain threshold, or if a particular user does not respond to the suggestions, activities, and/or commands that are supplied to help him or her. The notification enables others to be aware of at-risk learners.

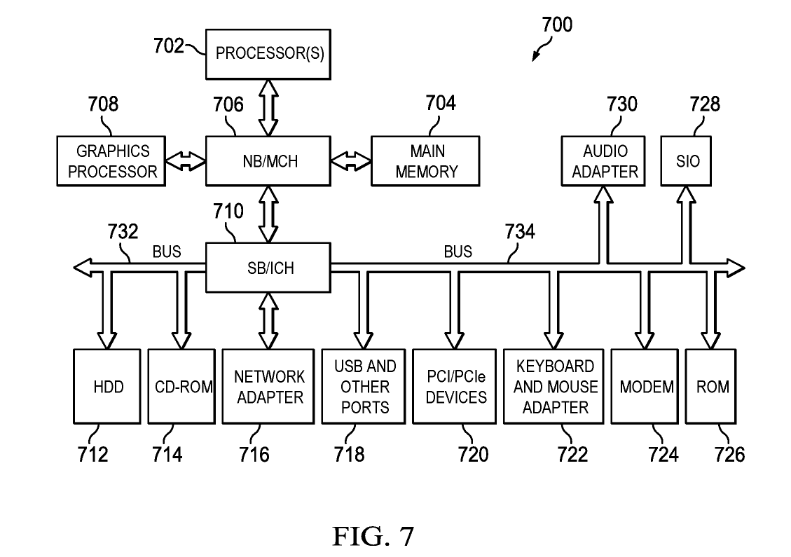

FIG. 7 is a block diagram of an adaptive learning adaptive learning system 700 in which various embodiments of the present disclosure may be implemented. For example, in one embodiment, the adaptive learning system 700 may be the end user device 150 in which the predictive learning module 100 and content item 160 are implemented and executed. Alternatively, the adaptive learning system 700 may represent a network device such as a server in which the predictive learning module 100 may be implemented and executed. The adaptive learning system 700 is just one embodiment for implementing the disclosed embodiments and is not intended to limit the disclosure or the claims. For instance, the disclosed embodiments may be implemented in various system configurations that may not include all the hardware components depicted in FIG. 7. Similarly, the disclosed embodiments may be implemented in various system configurations that may include additional hardware components that are not depicted in FIG. 7.

In the depicted example, the adaptive learning system 700 employs a hub architecture including north bridge and memory controller hub (NB/MCH) 706 and south bridge and input/output (I/O) controller hub (SB/ICH) 710. Processor(s) 702, main memory 704, and graphics processor 708 are connected to NB/MCH 706. Graphics processor 708 may be connected to NB/MCH 706 through an accelerated graphics port (AGP). A computer bus, such as bus 732 or bus 734, may be implemented using any type of communication fabric or architecture that provides for a transfer of data between different components or devices attached to the fabric or architecture.

In the depicted example, network adapter 716 connects to SB/ICH 710. Audio adapter 730, keyboard and mouse adapter 722, modem 724, read-only memory (ROM) 726, hard disk drive (HDD) 712, compact disk read-only memory (CD-ROM) drive 714, universal serial bus (USB) ports and other communication ports 718, and peripheral component interconnect/peripheral component interconnect express (PCI/PCIe) devices 720 connect to SB/ICH 710 through bus 732 and bus 734. PCI/PCIe devices 720 may include, for example, Ethernet adapters, add-in cards, and personal computer (PC) cards for notebook computers. PCI uses a card bus controller, while PCIe does not. ROM 726 may be, for example, a flash basic input/output system (BIOS). Modem 724 or network adapter 716 may be used to transmit and receive data over a network.

HDD 712 and CD-ROM drive 714 connect to SB/ICH 710 through bus 734. HDD 712 and CD-ROM drive 714 may use, for example, an integrated drive electronics (IDE) or serial advanced technology attachment (SATA) interface. Super I/O (SIO) device 728 may be connected to SB/ICH 710. In some embodiments, HDD 712 may be replaced by other forms of data storage devices including, but not limited to, solid-state drives (SSDs).

An operating system runs on processor(s) 702. The operating system coordinates and provides control of various components within the adaptive learning system 700 in FIG. 7. Non-limiting examples of operating systems include the Advanced Interactive Executive (AIX®) operating system or the Linux® operating system. Various applications and services may run in conjunction with the operating system such as those described herein.

The adaptive learning system 700 may include a single processor 702 or may include a plurality of processors 702. Additionally, processor(s) 702 may have multiple cores. For example, in one embodiment, adaptive learning system 700 may employ a large number of processors 702 that include hundreds or thousands of processor cores. In some embodiments, the processors 702 may be configured to perform a set of coordinated computations in parallel.

Instructions for the operating system, applications, and other data are located on storage devices, such as one or more HDD 712, and may be loaded into main memory 704 for execution by processor(s) 702. For example, in various embodiments, HDD 712 may store one or more content items, learner profiles, and computer executable instructions for generating selectable control items for a learner as disclosed herein. In some embodiments, additional instructions or data may be stored on one or more external devices. The processes for illustrative embodiments of the present invention may be performed by processor(s) 702 using computer usable program code, which may be located in a memory such as, for example, main memory 704, ROM 726, or in one or more peripheral devices 712 and 714.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically indicated, any reference to the processing, retrieving, and storage of data and computer executable instructions may be performed locally on an electronic device and/or may be performed on a remote network device. For example, data may be retrieved or stored on a data storage component of a local device and/or may be retrieved or stored on a remote database or other data storage systems. As referenced herein, the term database or knowledge base is defined as collection of structured or unstructured data. Although referred to in the singular form, the database may include one or more databases, and may be locally stored on a system or may be operatively coupled to a system via a local or remote network. Additionally, the processing of certain data or instructions may be performed over the network by one or more systems or servers, and the result of the processing of the data or instructions may be transmitted to a local device.

It should be apparent from the foregoing that the disclosed embodiments have significant advantages over current art. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments.

Further, the steps of the methods described herein may be carried out in any suitable order, or simultaneously where appropriate. For example, it is apparent that in certain embodiments, the process 500 of FIG. 5 may be combined with the process 400 of FIG. 4 and all performed by a singular module or process. In such an embodiment, the sending step (step 416 in FIG. 4) and the receiving step (step 502 in FIG. 5) of the optimal set of control items would be eliminated as the same process that generates the optimal set of control items also displays the optimal set of control items. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method executed by an adaptive learning system, the computer-implemented method comprising:
receiving a first set of user data associated with a learner;
storing the first set of user data;
predicting at least one user interaction activity based on the first set of user data;
identifying engagement factors for the user in the first set of user data;
determining a set of engagement models based on the at least one predicted user interaction event, the first set of user data, and the identified engagement factors; and
generating a first set of control items based on the set of engagement models.

2. The computer-implemented method of claim 1, wherein the first set of user data comprises historic learning data of the learner.

3. The computer-implemented method of claim 1, further comprising selecting an optimal set of control items based on at least one optimization objective and the first set of control items.

4. The computer-implemented method of claim 3, further comprising:
determining commands or shortcuts;
determining a location for displaying the optimal set of control items; and
displaying the optimal set of control items at the location of a display.

5. The computer-implemented method of claim 4, wherein the location is an unused space within the display.

6. The computer-implemented method of claim 4, further comprising:
determining an optimum time for displaying the optimal set of control items; and
displaying the optimal set of control items at the optimum time.

7. The computer-implemented method of claim 6, further comprising:
monitoring user interactions with the optimal set of control items; and
analyzing an outcome of the user interactions with the optimal set of control items.

8. The computer-implemented method of claim 7, further comprising performing an amelioration action in response to a determination that the outcome is a negative behavior.

9. The computer-implemented method of claim 8, wherein the amelioration action comprises deprioritizing at least one control item of the optimal set of control items that is associated with the negative behavior outcome.

10. The computer-implemented method of claim 8, wherein the amelioration action comprises employing a break-away avatar to interact with the learner.

11. An adaptive learning system comprising:
memory configured to store computer executable instructions; and
a processor configured to execute the computer executable instructions to:
receive a first set of user data associated with a learner;
store the first set of user data;
predict at least one user interaction activity based on the first set of user data;
identify engagement factors for the user in the first set of user data;
determine a set of engagement models based on the at least one predicted user interaction event, the first set of user data, and the identified engagement factors; and
generate a first set of control items based on the set of engagement models.

12. The adaptive learning system of claim 11, wherein the processor further executes instructions to select an optimal set of control items based on at least one optimization objective and the first set of control items.

13. The adaptive learning system of claim 12, wherein the processor further executes instructions to:
determine commands or shortcuts;
determine a location for displaying the optimal set of control items; and
display the optimal set of control items at the location of a display.

14. The adaptive learning system of claim 13, wherein the location is an unused space within the display.

15. The adaptive learning system of claim 13, wherein the processor further executes instructions to:
determine an optimum time for displaying the optimal set of control items; and
display the optimal set of control items at the optimum time.

16. The adaptive learning system of claim 13, wherein the processor further executes instructions to:
monitor user interactions with the optimal set of control items; and
analyze an outcome of the user interactions with the optimal set of control items.

17. The adaptive learning system of claim 16, wherein the processor further executes instructions to perform an amelioration action in response to a determination that the outcome is a negative behavior.

18. The adaptive learning system of claim 17, wherein the amelioration action comprises deprioritizing at least one control item of the optimal set of control items that is associated with the negative behavior outcome.

19. A computer program product for providing adaptive learning, the computer program product comprising a computer readable storage medium having program instructions embodied therewith, the program instructions executable by a processor of a system to cause the system to:
receive a first set of user data associated with a learner;
store the first set of user data;
predict at least one user interaction activity based on the first set of user data;
identify engagement factors for the user in the first set of user data;
determine a set of engagement models based on the at least one predicted user interaction event, the first set of user data, and the identified engagement factors;
generate a first set of control items based on the set of engagement models;
select an optimal set of control items based on at least one optimization objective and the first set of control items;
determine commands or shortcuts;
determine a location for displaying the optimal set of control items; and
display the optimal set of control items at the location of a display.

20. The computer program product of claim 19, wherein the program instructions executable by the processor further includes program instructions to:
determine an optimum time for displaying the optimal set of control items; and
display the optimal set of control items at the optimum time.
